(19) United States
(12) Patent Application Publication
(10) Pub. No.: US 2026/0195102 A1
(43) Pub. Date: Jul. 9, 2026

(54) MEASURING CODE GENERATION PERFORMANCE

(71) Applicant: INTERNATIONAL BUSINESS MACHINES CORPORATION, Armonk, NY (US)

(72) Inventors: Ulrich Alfons Finkler, Mahopac, NY (US); Gradus Janssen, Putnam Valley, NY (US)

(21) Appl. No.: 19/012,338

(22) Filed: Jan. 7, 2025

(51) Int. Cl. G06F 8/35

(52) U.S. Cl. CPC G06F 8/35

(57) ABSTRACT

Methods and systems for training a model include training models. Generated outputs are produced by the models using a set of input samples having respective golden outputs. The generated outputs are compared to the golden outputs according to a metric that generates a vector having elements determined by different prefixes. A best performing model is determined by comparison of the vectors. Further training is performed on the best performing model.

### BACKGROUND

The present invention generally relates to machine learning systems and, more particularly, to automated code generation.

Large language models (LLMs) are deep neural network models that can perform complex language processing tasks. In addition to natural language processing, LLMs can be used to perform tasks with programming language, such as translating a given program from one programming language to another to generating a code output according to input specifications.

However, generating programming code is nonetheless distinct from natural language processing. For example, programming code is more sensitive to order and syntax than natural language, where the change of a single character can render a generated output non-functional. Additionally, whereas an LLM may generate natural language text to any length, code generation is not open-ended.

### SUMMARY

A method for training a model includes training a model include training models. Generated outputs are produced by the models using a set of input samples having respective golden outputs. The generated outputs are compared to the golden outputs according to a metric that generates a vector having elements determined by different prefixes. A best performing model is determined by comparison of the vectors. Further training is performed on the best performing model.

A computer program product includes one or more computer-readable storage media. Program instructions are stored on the one or more computer-readable storage media to perform operations that include training models, producing generated outputs by the models using a set of input samples having respective golden outputs, comparing the generated outputs to the golden outputs according to a metric that generates a vector having elements determined by different prefixes, determining a best performing model by comparison of the vectors, and performing further training on the best performing model.

A computer system includes a processor set and one or more computer-readable storage media. Program instructions stored on the one or more computer-readable storage media to cause the processor set to perform operations that include training models, producing generated outputs by the models using a set of input samples having respective golden outputs, comparing the generated outputs to the golden outputs according to a metric that generates a vector having elements determined by different prefixes, determining a best performing model by comparison of the vectors, and performing further training on the best performing model.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block diagram of a distributed computing system, in accordance with an embodiment of the present invention;

FIG. 2 is a block diagram of a processing node in a distributed computing system which can automatically deploy containers using machine-generated playbooks, in accordance with an embodiment of the present invention;

FIG. 3 is a diagram illustrating context and a prompt to generate a playbook, in accordance with an embodiment of the present invention;

FIG. 4 is a block/flow diagram illustrating model selection for code generation, in accordance with an embodiment of the present invention;

FIG. 5 is a diagram illustrating different exemplary outputs of code generation models, in accordance with an embodiment of the present invention;

FIG. 6 is a block/flow diagram of a method for selecting and training a best-performing code generation model, in accordance with an embodiment of the present invention;

FIG. 7 is a block/flow diagram of a method of configuring a distributed computing system using automatically generated playbook code, in accordance with an embodiment of the present invention;

FIG. 8 is a block diagram of a computing environment that can perform code generation with performance measurement, in accordance with an embodiment of the present invention;

FIG. 9 is a diagram of an exemplary machine learning architecture that can be used to implement a large language model, in accordance with an embodiment of the present invention; and

FIG. 10 is a diagram of an exemplary deep machine learning architecture that can be used to implement a large language model, in accordance with an embodiment of the present invention.

### DETAILED DESCRIPTION

There are a variety of large language models (LLMs) available for performing language processing tasks using programming languages. However, evaluating the performance of such models for any particular task is challenging. A suitable metric is needed that has provable mathematical properties and provides deeper insights beyond a simple output score. A metric function is therefore described herein that makes use of a set of predictions and a set of “golden” outputs for a model. The metric generates a vector of values, which evaluate the metric function at a variety of different parameters (e.g., prefix length). This makes it possible to compare a set of different models across a set of different parameters, so that the globally optimum combination of model and parameters can be selected for use.

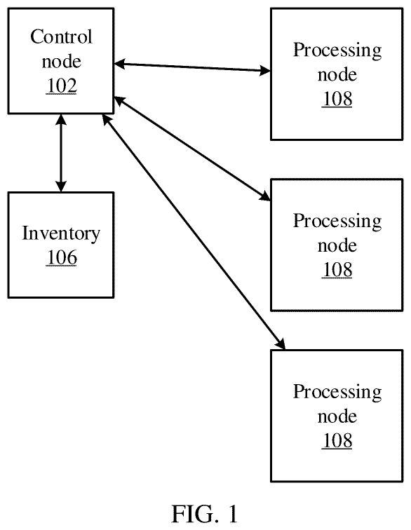

Referring now to FIG. 1, a cloud computing system is shown where code may be automatically generated to configure the system. A control node 102 interacts with a number of processing nodes 108, each of which represents a separate logical or physical processing system. An inventory 106 includes a list of processing nodes 108 that are managed by the control node 102, which may be used to describe deployments.

In some embodiments, ANSIBLE® may be used on the control node 102 to manage a container orchestration system, such as KUBERNETES®. In such embodiments, an ANSIBLE® playbook may make use of a KUBERNETES® module to implement container orchestration, including deployment and configuration of containers on the processing nodes 108. The control node 102 may make use of a variety of ANSIBLE® modules, each of which may represent program code that may run on one or more processing nodes 108. The playbook may be a text file on the control node 102 that indicates how the modules, plugins, and roles may be used, and may be defined in a YAML format. For example, the playbook may be used to configure the download and installation of packages for a service and can further provide configuration for that service.

Rather than writing an ANSIBLE® playbook by hand, an LLM may be used to generate one based on a text description prompt. ANSIBLE® represents a code environment, in which order and syntax are important to the functioning of the playbook and, thus, to the functioning of the cloud computing system.

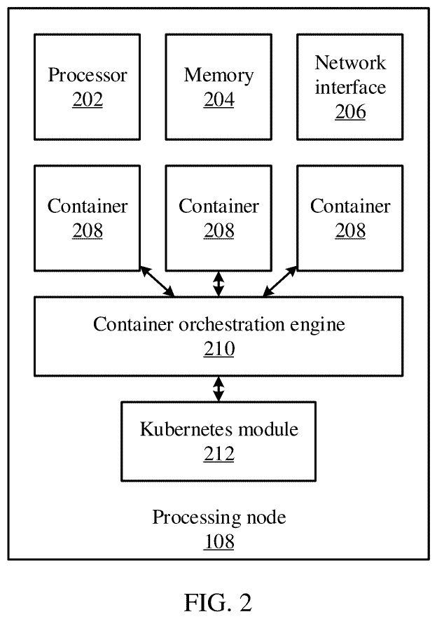

Referring now to FIG. 2, additional detail on a processing node 108 is shown. The processing node 108 includes a hardware processor 202, a memory 204, and a network interface 206. The network interface 206 is configured to communicate with the control node 102 and with other processing nodes 108 as needed, using any appropriate wired or wireless communications medium and protocol. The processing node 108 also includes one or more functional modules that may, in some embodiments, be implemented as software that is stored in the memory 204 and that is executed by the hardware processor 202. In other embodiments, one or more of the functional modules may be implemented as one or more discrete hardware components in the form of, e.g., application-specific integrated chips or field programmable gate arrays.

The processing node 108 includes one or more containers 208. It is specifically contemplated that each container 208 represents a distinct operating environment. The containers 208 each include a set of software applications, configuration files, workload datasets, and any other information or software needed to execute a specific workload. The containers 208 are stored in memory 204 and are instantiated and decommissioned by the container orchestration engine 210 as needed. It should be understood that, as a general matter, an operating system of the processing node 108 exists outside the containers 208. Thus, each container 208 interfaces with the same operating system kernel, reducing the overhead needed to execute multiple containers simultaneously. The containers 208 meanwhile generally have no communication with one another outside of specifically agreed-to interfaces, reducing security concerns.

The container orchestration engine 210 may be implemented or managed by a KUBERNETES® module 212, which in turn may have been deployed and configured by the control node 102. In addition to the KUBERNETES® module 212, a number of other modules may be deployed by the control node 102 in accordance with a playbook.

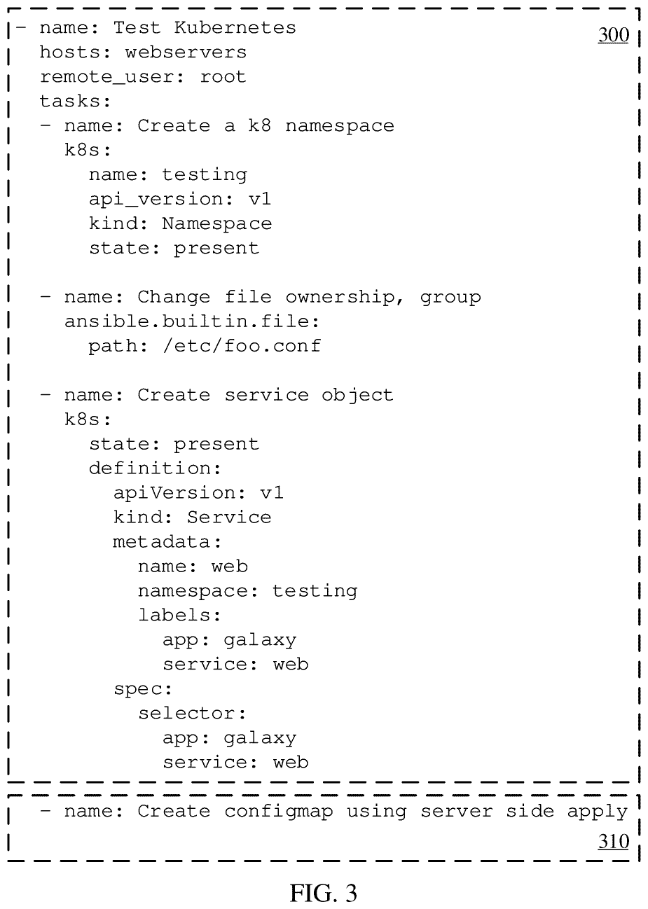

Referring now to FIG. 3, an exemplary combination of the context 300 and prompt 310 is shown. The context 300 includes a partial playbook definition, including whatever elements of the playbook that the user cares to input by hand. The prompt 310 includes, in this case, a description of the function that is to be implemented. This prompt 310 and the context 300 are used as input to an LLM that is trained on ANSIBLE® playbooks to generate additional the rest of the playbook, filling out the prompt 310 with appropriate values.

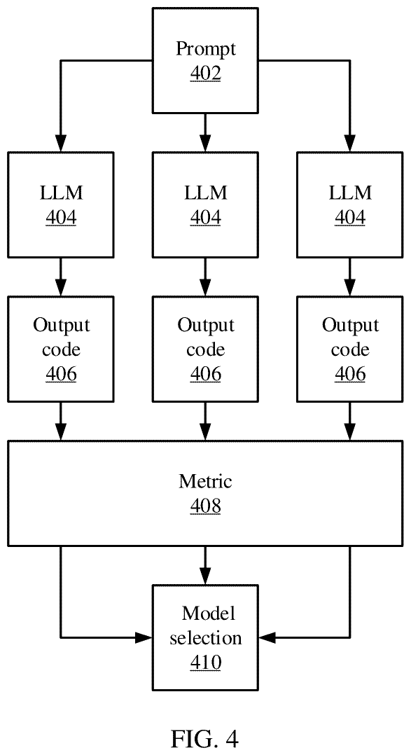

Referring now to FIG. 4, a system for model selection and code generation is shown. A prompt 402 is provided for code generation, for example to generate a playbook. The prompt 402 may include context and a textual description of the code that is to be generated. The prompt 402 is used as input to a set of LLMs 404. The LLMs 404 are different from one another. In some embodiments the LLMs 404 may include different models. In some embodiments, some of the LLMs 404 may include the same model, implemented with different numbers of parameters.

The outputs 406 of the LLMs 404 are checked for quality according to a metric 408. The metric 408 compares the outputs 406 to golden outputs for the LLMs 404, with the golden outputs representing predetermined known-good output values. For each output 406, the metric 408 produces a vector of values, with each element of the vector representing a measurement according to a different parameter. Based on these metric output vectors, model selection 410 selects one of the LLMs 404 to use in the code generation task.

The function used for the metric 408 may be selected from a set of different possibilities. For example, the Levenshtein distance and/or the Hamming distance may be used. These metrics can provide sensitivity to functionality of the output, differentiation between major errors and minor errors, relatability between the distance and how much work is needed to fix the generated code, usable granularity that focuses on parts of the generated whole, and provable mathematical properties such as satisfying the triangle inequality.

The metric 408 may be implemented as a unit incremental metric. A unit, as used herein, is a part of an output 406 that is based on a grammar of the language being used. For example, in C, a unit may be defined as a scope defined by opening and closing braces ‘{’ and ‘}’ and/or by semicolons. In Python, a unit may be defined as a line, with line ends in strings being considered masked. This definition varies from one programming language to the next. For example, unlike in Python, the line structure of C has little semantic meaning. Thus, units may be defined according to syntactic features of the programming language.

The Levenshtein distance and Hamming distance are examples of metrics where a minimum edit distance corresponds to keystrokes needed to fix an error in the generated code. Although these metrics are specifically contemplated, it should be understood that other functions may be used instead.

The metric 408 may be applied to incrementally increasing prefixes. For example, a first comparison may be measured between the output 406 and the golden output with a prefix of the first unit, a second comparison may be measured between the output 406 and the golden output with a prefix of the first two units, and so on. The output of the metric 408 according to each different prefix length generates a respective element value of the metric's output vector for the output 406. Samples that are shorter than a maximum sample or prediction length may be right-padded with empty units. The metric value at the n^{th} prefix may be interpreted as a chosen distance function for the first n units. Metric vectors may be aggregated using an element-wise sum, which can be used to generate average values across multiple samples.

An exemplary set of outputs from the metric 408 are shown in Table 1, for three different models. This example shows how the different models perform on a playbook generation task with a set of examples, each example being associated with a predetermined “golden” playbook output. The metric measures the Levenshtein distance between the generated output 406 and the golden output for each sample, aggregated across the samples. This output shows that, while the difference between the models decreases with larger prefix lengths, there is a much larger difference at smaller prefix lengths (where Model 3 performs best).

Block 410 compares these outputs to determine which model is best suited for a given task. For example, the comparison may determine whether a model generates outputs of usable quality. The comparison may furthermore provide insight into the performance of a single model that has been trained or fine-tuned with different training data and/or hyperparameters. This may be performed on a relatively small training dataset to provide insight on which parameters should be used when training on a full dataset.

TABLE 1

| | Prefix 1 | Prefix 2 | Prefix 3 | Prefix 4 | Prefix 5 | Prefix 6 | Prefix 7 | Prefix 8 |
|---|---|---|---|---|---|---|---|---|
| Model 1 | 27.0 | 50.6 | 73.4 | 105.5 | 135.5 | 167.14 | 199.3 | 231.1 |
| Model 2 | 17.2 | 50.7 | 71.2 | 98.1 | 125.8 | 157.1 | 190.3 | 230.3 |
| Model 3 | 16.9 | 34.6 | 53.5 | 76.5 | 101.9 | 130.0 | 160.0 | 189.6 |

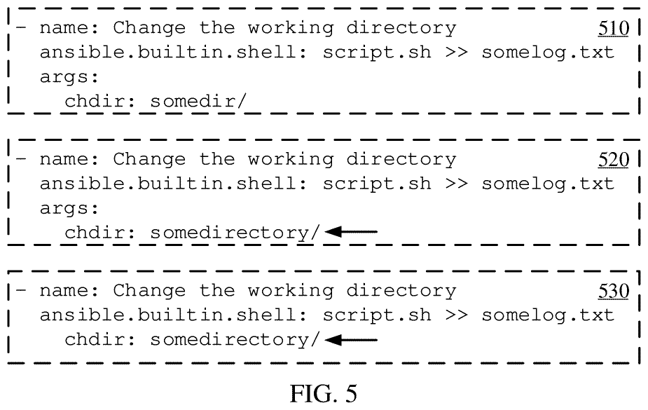

Referring now to FIG. 5, an example of a golden output 510, a first generated output 520 from a first model, and a second generated output 530 from a second model is shown. In YAML a unit may be defined as a line, so each of these outputs includes four units. When using the Levenshtein distance as a metric, the metric vector for the first generated output 520 may be determined as in Table 2.

TABLE 2

| Prefix 1 | Prefix 2 | Prefix 3 | Prefix 4 |
|---|---|---|---|
| 0 | 0 | 0 | 6 |

In other words, the first three units are identical, but the fourth unit needs six edits to turn the generated output 520 into the golden output 510—deleting the characters “ectory”. For the second generated output 530, with the metric vector shown in Table 3, the third line is omitted entirely. When considering the first three lines, the difference is significant, as the entire third line of the second generated output 530 needs to be changed to match the golden output 510. When considering four lines, however, the difference is smaller as the skipped line is interpreted as being empty.

TABLE 3

| Prefix 1 | Prefix 2 | Prefix 3 | Prefix 4 |
|---|---|---|---|
| 0 | 0 | 6 + 23 | 6 + 8 |

Multiple samples are used to judge the performance of a given model, as the results are noisy and any individual sample may be an outlier. Predictions tend to be better with fewer units, and errors increase as more units are considered. If there is a large error at the start, this often indicates that the model has made a systematic error, such as producing an incorrect leading output. There may also be a range where the performance is flat at the beginning, before it starts to climb. This may indicate that the model has started to generate unbounded text, for example by repeating itself or by continuing to generate output past the correct stopping point. The slope of the scores in the stable part gives information about the average error per unit, with the ideal slope being flat and zero. If the scores drop, this may indicate that the model has forgotten things, as illustrated in Table 3.

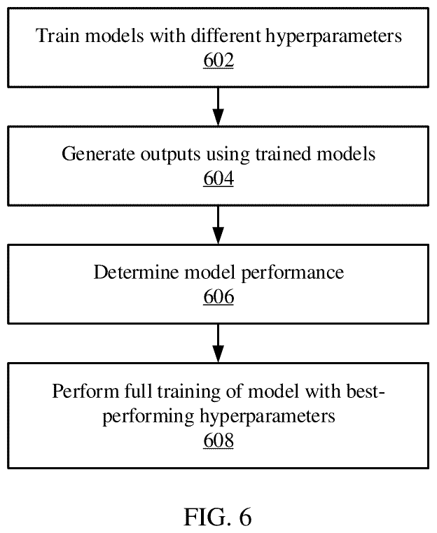

Referring now to FIG. 6, a method of performing model training is shown. Block 602 trains a given model with multiple distinct sets of hyperparameters, generating multiple trained models. In some cases this training may include models of differing neural network architectures, such there may be models that vary by architecture as well as models of a same architecture that vary by hyperparameters. This training may be performed on a subset of a full training dataset to reduce training time and cost. Block 604 generates code outputs using the trained models according to a set of samples that have respective predetermined golden outputs.

Block 606 determines each model's performance as described above, aggregating the metric vectors of the outputs from each respective model. Block 606 compares the aggregated metric vectors to determine a best-performing model and its associated hyperparameters. Block 608 then completes the training of the best-performing model using the full training dataset.

Distance-based heuristics may be used to determine which model performs the best. For example, an optimal distance for prefix lengths may be set as being greater than or equal to a length of the golden solution. For each sample in a set, the minimal distance for all prefixes that are greater than or equal to the length of the golden solution may be averaged. Another heuristic may be based on a full edit distance, which measures the distance from the maximum of the length of the prediction to the length of the golden solution. If the two numbers are close, then the full distance is a good indicator for model quality. If the numbers are very different (e.g., greater than a threshold distance apart), then the model does not stop well and may need additional training.

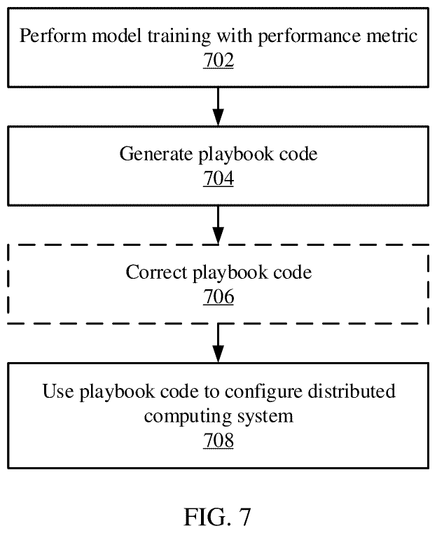

Referring now to FIG. 7, a method of generating and using playbook code is shown. Block 702 performs model training, using the performance metric described above to select hyperparameters. Once the model has been trained, block 704 generates playbook code according to an input prompt using the model. If necessary, a human operator may review the model's output and perform any corrections needed. Block 708 may then use the playbook code to configure a distributed computing system.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 800 contains an example of an environment for the execution of at least some of the computer code involved in performing the inventive methods, such as code generation with performance measurement 819. In addition to block 200, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 200, as identified above), peripheral device set 814 (including user interface (UI) device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

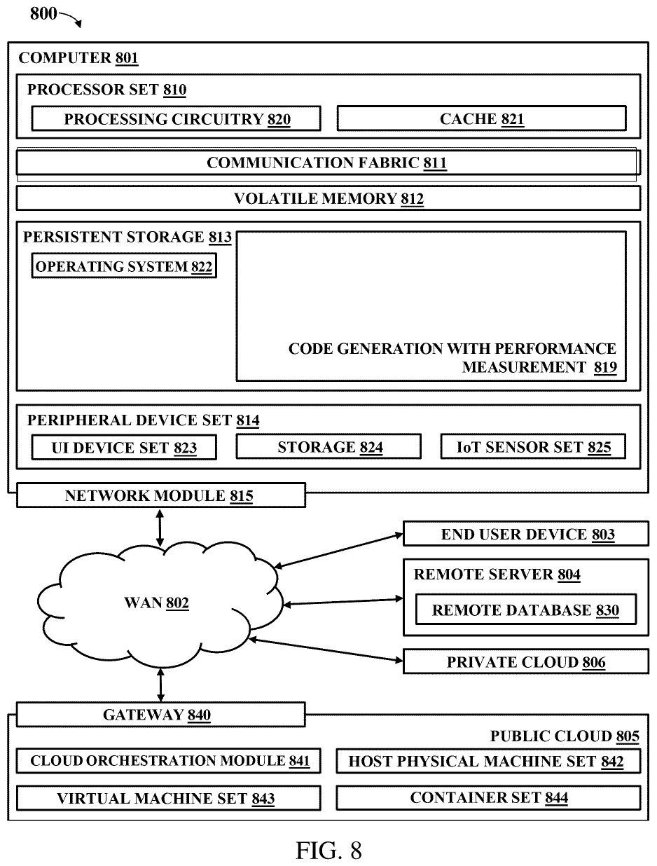

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 200 in persistent storage 813.

COMMUNICATION FABRIC 811 is the signal conduction path that allows the various components of computer 801 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, volatile memory 812 is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815. WAN 802 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802. Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

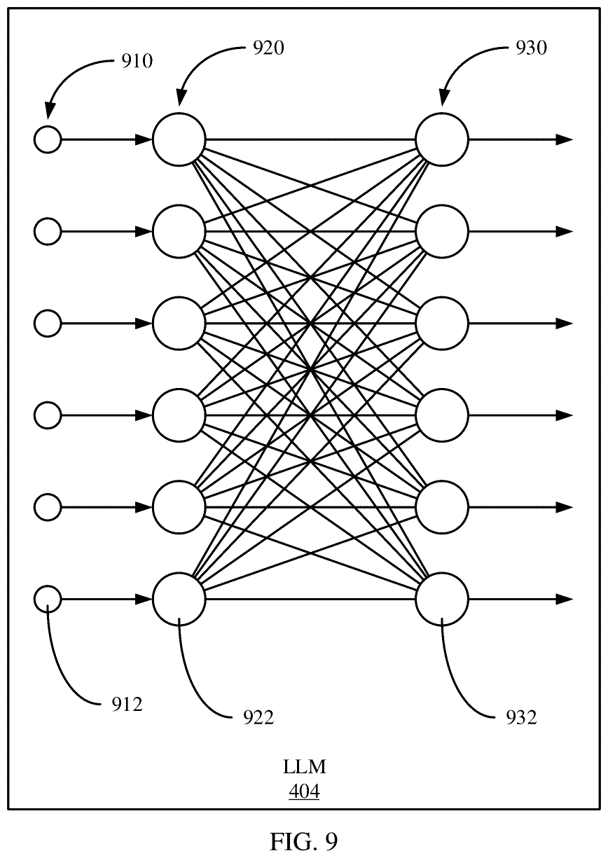

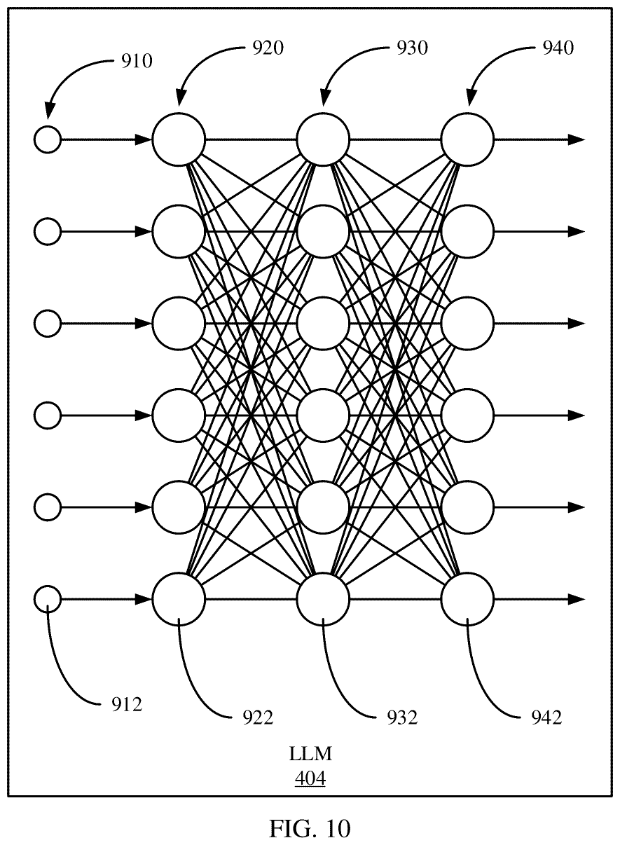

Referring now to FIGS. 9 and 10, exemplary neural network architectures are shown, which may be used to implement parts of the present models, such as LLM 404. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be outputted.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 920 of source nodes 922, and a single computation layer 930 having one or more computation nodes 932 that also act as output nodes, where there is a single computation node 932 for each possible category into which the input example could be classified. An input layer 920 can have a number of source nodes 922 equal to the number of data values 912 in the input data 910. The data values 912 in the input data 910 can be represented as a column vector. Each computation node 932 in the computation layer 930 generates a linear combination of weighted values from the input data 910 fed into input nodes 920, and applies a non-linear activation function that is differentiable to the sum. The exemplary simple neural network can perform classification on linearly separable examples (e.g., patterns).

A deep neural network, such as a multilayer perceptron, can have an input layer 920 of source nodes 922, one or more computation layer(s) 930 having one or more computation nodes 932, and an output layer 940, where there is a single output node 942 for each possible category into which the input example could be classified. An input layer 920 can have a number of source nodes 922 equal to the number of data values 912 in the input data 910. The computation nodes 932 in the computation layer(s) 930 can also be referred to as hidden layers, because they are between the source nodes 922 and output node(s) 942 and are not directly observed. Each node 932, 942 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the inputted data. A deep neural network can be fully connected, where each node in a computational layer is connected to all other nodes in the previous layer, or may have other configurations of connections between layers. If links between nodes are missing, the network is referred to as partially connected.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of measuring code generation performance (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method for training a model, comprising:
training a plurality of models;
producing generated outputs by the plurality of models using a set of input samples having respective golden outputs;
comparing the generated outputs to the golden outputs according to a metric that generates a vector having elements determined by different prefixes;
determining a best performing model of the plurality of models by comparison of the vectors; and
performing further training on the best performing model.

2. The method of claim 1, wherein the samples are code generation prompts and the golden outputs are predetermined code that corresponds to the respective code generation prompts.

3. The method of claim 2, wherein the prefixes correspond to a number of units of the generated outputs and the golden outputs.

4. The method of claim 3, wherein the units are defined according to syntactic features of a language being generated.

5. The method of claim 1, wherein training the plurality of models includes training a given model architecture a plurality of times according to differing hyperparameters.

6. The method of claim 1, wherein training the plurality of models includes training a plurality of model architectures.

7. The method of claim 1, wherein the metric determines a Levenshtein distance or Hamming distance between a generated output and a respective golden output for each of the different prefixes.

8. The method of claim 1, wherein comparing the generated outputs to the golden outputs includes aggregating vectors for each model across the set of input samples.

9. The method of claim 1, further comprising generating playbook code using the best performing model after performing further training and implementing the playbook code in a distributed computing system.

10. The method of claim 1, wherein determining the best performing model uses a distance-based heuristic.

11. A computer program product, comprising:
one or more computer-readable storage media; and
program instructions stored on the one or more computer-readable storage media to perform operations comprising:
training a plurality of models;
producing generated outputs by the plurality of models using a set of input samples having respective golden outputs;
comparing the generated outputs to the golden outputs according to a metric that generates a vector having elements determined by different prefixes;
determining a best performing model of the plurality of models by comparison of the vectors; and
performing further training on the best performing model.

12. A computer system, comprising:
a processor set;
one or more computer-readable storage media; and
program instructions stored on the one or more computer-readable storage media to cause the processor set to perform operations comprising:
training a plurality of models;
producing generated outputs by the plurality of models using a set of input samples having respective golden outputs;
comparing the generated outputs to the golden outputs according to a metric that generates a vector having elements determined by different prefixes;
determining a best performing model of the plurality of models by comparison of the vectors; and
performing further training on the best performing model.

13. The system of claim 12, wherein the samples are code generation prompts and the golden outputs are predetermined code that corresponds to the respective code generation prompts.

14. The system of claim 13, wherein the prefixes correspond to a number of units of the generated outputs and the golden outputs.

15. The system of claim 14, wherein the units are defined according to syntactic features of a language being generated.

16. The system of claim 12, wherein training the plurality of models includes training a given model architecture a plurality of times according to differing hyperparameters.

17. The system of claim 12, wherein training the plurality of models includes training a plurality of model architectures.

18. The system of claim 12, wherein the metric determines a Levenshtein distance or Hamming distance between a generated output and a respective golden output for each of the different prefixes.

19. The system of claim 12, wherein comparing the generated outputs to the golden outputs includes aggregating vectors for each model across the set of input samples.

20. The system of claim 12, further comprising generating playbook code using the best performing model after performing further training and implementing the playbook code in a distributed computing system.
